(19) United States
(12) Patent Application Publication
(10) Pub. No.: US 2024/0202306 A1
(43) Pub. Date: Jun. 20, 2024

(54) DATA PLANE PROXY WITH AN EMBEDDED OPEN POLICY AGENT FOR MICROSERVICES APPLICATIONS

(71) Applicant: KONG INC., San Francisco, CA (US)

(72) Inventor: Harry Bagdi, Seattle, WA (US)

(21) Appl. No.: 18/498,962

(22) Filed: Oct. 31, 2023

Related U.S. Application Data
(60) Provisional application No. 63/476,050, filed on Dec. 19, 2022.

(51) Int. Cl. G06F 21/44

(52) U.S. Cl. CPC G06F 21/44

(57) ABSTRACT

Disclosed embodiments are directed to a data plane proxy with an embedded open policy agent for a microservices application. An example method for authorizing requests in the microservices application that includes multiple services, each service being an application program interface (API) performing a piecemeal function of an overall application function, includes receiving, by a service of the multiple services, a request for access or utilization of the service. The service includes a data plane proxy that is configured to perform at least one of routing, load balancing, authentication and authorization, service discovery, or health checking for the service. The method further includes determining, by an open policy agent module embedded in the data plane proxy, whether to authorize the request, and transmitting, based on the determining, a decision that authorizes or rejects the request.

### CROSS-REFERENCE TO RELATED APPLICATIONS

This application claims the benefit of priority to U.S. Provisional Application No. 63/476,050 filed Dec. 19, 2022, which is incorporated by reference herein in its entirety.

### TECHNICAL FIELD

The disclosure relates to distributed microservice application networks and more particularly to architecture and data flow between application programming interfaces.

### BACKGROUND

Application programming interfaces (APIs) are specifications primarily used as an interface platform by software components to enable communication with each other. For example, APIs can include specifications for clearly defined routines, data structures, object classes, and variables. Thus, an API defines what information is available and how to send or receive that information.

Microservices are a software development technique-a variant of the service-oriented architecture (SOA) architectural style that structures an application as a collection of loosely coupled services (embodied in APIs). In a microservices architecture, services are fine-grained and the protocols are lightweight. The benefit of decomposing an application into different smaller services is that it improves modularity. The improvement to modularity makes the application easier to understand, develop, test, and become more resilient to architecture erosion. Microservices parallelize development by enabling small autonomous teams to develop, deploy and scale their respective services independently. Microservice-based architectures enable continuous delivery and deployment.

Setting up multiple APIs is a time-consuming challenge because deploying an API requires tuning the configuration or settings of each API individually. The functionalities of each individual API are confined to that specific API and servers hosting multiple APIs are individually set up for hosting the APIs, which makes it very difficult to build new APIs or even scale and maintain existing APIs. Maintaining APIs becomes even more challenging when there are tens of thousands of APIs and millions of clients requesting API-related services per day. Consequently, visualizing these APIs is a tedious and cumbersome activity.

### BRIEF DESCRIPTION OF THE DRAWINGS

FIG. 1A illustrates a prior art approach with multiple APIs having functionalities common to one another.

FIG. 1B illustrates a distributed API gateway architecture, according to an embodiment of the disclosed technology.

FIG. 2A illustrates a prior art approach of implementing an open policy agent (OPA) external to a service to authorize requests to the service.

FIG. 2B illustrates an embedded OPA in a service, according to an embodiment of the disclosed technology.

FIG. 3 is a block diagram of a control plane system for a service mesh in a microservices architecture.

FIG. 4 is a flowchart illustrating a method of authorizing requests in a microservices architecture application.

FIG. 5 depicts a diagrammatic representation of a machine in the example form of a computer system within a set of instructions, causing the machine to perform any one or more of the methodologies discussed herein, to be executed.

### DETAILED DESCRIPTION

In a microservices application architecture, the control plane operates between each application programming interface (API) that makes up the microservices application architecture. Proxies operate linked to each API. The proxy attached to each API is referred to as a “data plane proxy.”

The control plane is responsible for determining rules and policies directed to handling network packets. In an example, the control plane determines what kinds of packets should get routed to specific host machines? What kinds of packets should get rejected? How do we determine which packets go to which host? What should the router do if packets get dropped? In another example, the control plane processes requests and responses that enable the establishment of rules and policies. In general, the control plane establishes policy, and a data plane proxy carries out the policies that were established by the control plane. For example, the data plane proxy performs packet switching by evaluating packet addresses against the network policies and then does the work of getting those packets to the right destination. Examples of a data plane proxy include the sidecar proxies or Envoy proxies.

The disclosed technology describes how to improve the functionality of a data plane proxy in a service of a microservices application. In an example, this is achieved by embedding an open policy agent (OPA) into the data plane proxy of a service in a microservices application. An OPA embedded into the data plane proxy advantageously enables the implementation of standardized authentication and authorization rules via a native “OPA Policy” that is consistently applied across workloads, regardless of language, platform, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure are directed at systems, methods, and architecture for management of microservices APIs that together comprise an application. The architecture is a distributed cluster of gateway nodes that jointly provide APIs. As a result of a distributed architecture, the task of API management is distributed across a cluster of gateway nodes or even web services. For example, some APIs that make up the microservices application architecture run on Amazon AWS®, whereas others operate on Microsoft Azure®. It is feasible that the same API runs multiple instances (e.g., multiple workers) on both AWS and Azure (or any other suitable web hosting service).

The gateway nodes effectively become the entry point for API-related requests from users. Requests that operate in between APIs (e.g., where one API communicates to another API) may have architecturally direct communication, though indicate communications/request response transactions to a control plane via data plane proxies. In some embodiments, inter-API requests pass through a gateway depending on network topology, API configuration, or stewardship of an associated API. The disclosed embodiments are well-suited for use in mission critical deployments at small and large organizations. Aspects of the disclosed technology do not impose any limitation on the type of APIs. For example, these APIs can be proprietary APIs, publicly available APIs, or invite-only APIs.

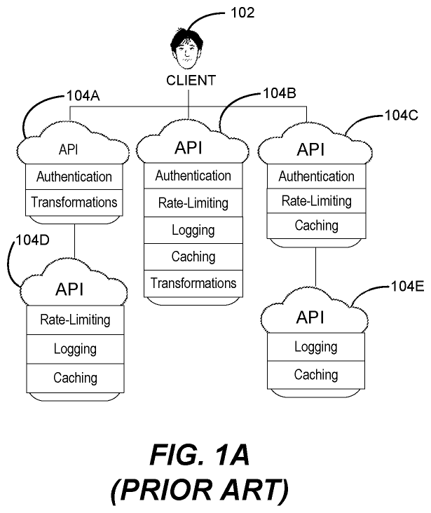

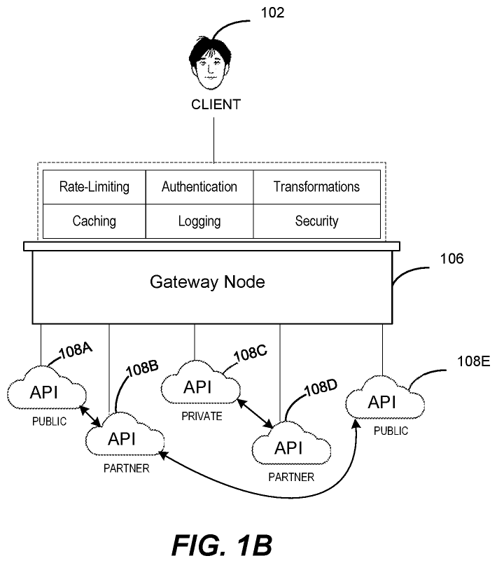

FIG. 1A illustrates a prior art approach with multiple APIs having functionalities common to one another. As shown in FIG. 1A, a client 102 is associated with APIs 104A, 104B, 104C, 104D, and 104E. Each API has a standard set of features or functionalities associated with it. For example, the standard set of functionalities associated with API 104A are “authentication” and “transformations.” The standard set of functionalities associated with API 104B are “authentication,” “rate-limiting,” “logging,” “caching,” and “transformations.” Thus, “authentication” and “transformations” are functionalities that are common to APIs 104A and 104B. Similarly, several other APIs in FIG. 1A share common functionalities. However, it is noted that having each API handle its own functionalities individually causes duplication of efforts and code associated with these functionalities, which is inefficient. The inefficiency problem becomes significantly more challenging when there are tens of thousands of APIs and millions of clients requesting API-related services per day.

FIG. 1B illustrates a distributed API gateway architecture according to an embodiment of the disclosed technology. To address the challenge described in connection with FIG. 1A, the disclosed technology provides a distributed API gateway architecture as shown in FIG. 1B. Specifically, disclosed embodiments implement common API functionalities by bundling the common API functionalities into a gateway node 106 (also referred to herein as an API Gateway). Gateway node 106 implements common functionalities as a core set of functionalities that runs in front of APIs 108A, 108B, 108C, 108D, and 108E. The core set of functionalities include rate limiting, caching, authentication, logging, transformations, and security. It will be understood that the above-mentioned core set of functionalities are for examples and illustrations. There can be other functionalities included in the core set of functionalities besides those discussed in FIG. 1B. In some applications, gateway node 106 helps launch large-scale deployments in a very short time at reduced complexity and is therefore an inexpensive replacement for expensive proprietary API management systems.

The common functionalities being bundled in the gateway API enables client requests to be directed to the gateway API and then forwarded to the specific service (and corresponding API) that is being requested. The service receiving the request typically authenticates and authorizes the incoming request prior to the corresponding services being provided to the requesting client.

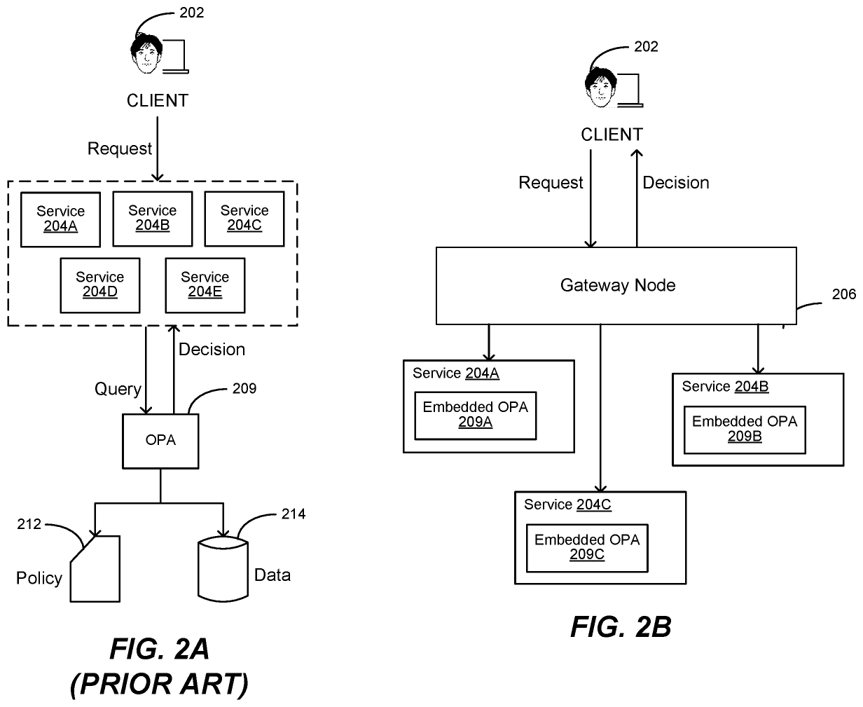

FIG. 2A is a block diagram illustrating an existing, or prior art, implementation using an open policy agent (OPA) to authorize requests to one or more services. As illustrated therein, the client 202 transmit a request to one of multiple services (204A, . . . , 204E) that the client wishes to use. A specific service (e.g., 204B) receives the request and converts the request into, for example, a JavaScript Object Notation (JSON) formatted query that is transmitted to the open policy agent (OPA) 209.

An open policy agent (OPA) is a policy engine that automates and unifies the implementation of policies across IT environments, especially in cloud native applications. Using an OPA transfers management of service level policies from individual applications to a centralized policy manager such that policy decisions are always separated from policy execution. Because the OPA is domain-agnostic, almost any policy (in any form) may be enforced, e.g., which users are authorized to access which resources? Which clusters a workload must be deployed to? Which times of day is the system accessible? And the like.

In a cloud-native environment, the OPA is typically used for a variety of tasks, which include application authorization (e.g., policies and rules being integrated into an application; end users being granted permission to contribute policies for tenants), Kubernetes® admission control (e.g., built-in features that provide capabilities for enforcing admission policies being extended), and service mesh authorization (e.g., lateral movement being limited across a microservice architecture and compliance regulations being enforced).

In some embodiments, an OPA is implemented using a query (or declarative) language (e.g., Rego, which is based on Datalog) that enables the definition of assertions and provides clear binary decisions about policy questions. The policy decisions need not be limited to simple yes/no or allow/deny answers, but can take the form of arbitrary structured data as required.

Referring back to FIG. 2A, the OPA 209 receives the JSON formatted query and generates a corresponding JSON formatted decision based on existing policies (e.g., stored in policy repository 212) and data already provided to it (e.g., stored in data repository 214). In an example, the decision generated by the OPA 209 either approves or denies the request that was received from the service 204B, which forwards the decision back to the client 202. In another example, the OPA 209 generates a hierarchical data structure that is used by the service 204B to provide the necessary information to the client 202.

Existing implementations typically deploy an OPA that is distinct from the available set of services in order to provide decoupled authorization control for each of the (micro)services being serviced by the OPA. That is, the policy decision is decoupled from the policy enforcement.

In contrast to existing implementations, FIG. 2B illustrates a service with an embedded OPA, according to an embodiment of the disclosed technology. As shown therein (and with reference to FIG. 1B), the client 202 sends a request to a gateway node 206, which forwards the request to the request to the specific service the client intended to access, e.g., 204B. In the architecture show in FIG. 2B, each service (204A, 204B, 204C) includes an embedded OPA (209A, 209B, 209C, respectively). When the intended service 204B receives the request from the client 202 (via the gateway node 206), the embedded OPA 209B enforces the policies of that particular service, and generates a decision that is forwarded back to the client 202. In some embodiments, the embedded OPA shown in FIG. 2B includes a policy repository (e.g., 212 in FIG. 2A) and a data repository (e.g., 214 in FIG. 2A) that are used to generate a context-aware decision to the request received by service from the client.

The term “embedded,” as used herein, refers to the incorporation of a component and/or software module (the embedded system or embedded software) into another component and/or software module such that the embedded system or software performs specialized functions and operates within the requirements, capabilities, and/or constraints of the component or software it is embedded in. In contrast to application software, which provides certain functionality on a device by using the available capabilities of the device, embedded software has fixed hardware and software requirements, capabilities, and/or constraints that are a function of the component or software it is embedded in.

An embedded component and/or software module is typically task-specific, e.g., it executes the same pre-programmed function throughout its usable life and cannot be altered, and high-efficiency, e.g., the resource requirements of the embedded entity never exceeds the capacity of the component or software it is installed on (or embedded in), and highly reliable and stable, e.g., its tasks are performed with consistent response times and functionality throughout the lifetime of the device/software that houses them.

Embodiments of the disclosed technology provide, as illustrated in FIG. 2B, each (micro)service with a data plane proxy that has an embedded OPA. The embedded OPA provides, among others, the following advantages and benefits:

No additional OPA agent sidecars need to be deployed or managed. The described embodiments provide an OPA policy engine embedded into the data plane proxy for various implementations (e.g., Kubernetes® or virtual machines), thereby negating the need to deploy an additional sidecar for policy management and enforcement, and advantageously simplifying day-2 operations (e.g., maintaining, monitoring, and optimizing).

Standardized authentication and authorization rules can be implemented out of the box. The disclosed embodiments consistently apply a native OPA policy across workloads, regardless of language, platform, etc. Applying a consistent native OPA policy enables the seamless and automatic propagation of the OPA policy across every zone, cloud and cluster while still allowing users to connect to remote OPA servers like Styra to manage the OPA policies of those users.

In an example, the standardized authentication and authorization rules include the control plane configuring the embedded OPA with a specified policy and configuring Envoy (an example of a high-performance C++ distributed proxy designed for single services and applications) to use external authorization that points to the embedded OPA. In another example, custom configuration and other policies (e.g., defined in the Rego language) are provided to the embedded OPA.

Context-aware policies can be enforced. Compared to existing implementations, the embedded OPA is uniquely positioned to remain decoupled from the microservice itself (i.e., the policy implementation and services provided by the microservice), but provide extremely fast and efficient authorization and authentication decisions because it is operating entirely within the confines of the data plane proxy, and is subject to its requirements, capabilities, and constraints.

In some embodiments, the embedded OPA (e.g., 209B in service 204B in FIG. 2B) is configured to provide authentication in systems that use JSON Web Tokens (JWTs). In an example, the client (e.g., client 202) is provided with a JWT that encodes, for example, group membership of the client and other client attributes. The client provides the JWT along with the request to the gateway node, which forwards both the token and the request to the service. The service is configured to include the JWT as part of the input to the embedded OPA, which decodes the token and uses it to perform an authentication operation as part of generating the policy decision in response to the request. In this example, the embedded OPA includes one or more primitives (e.g., a low-level cryptographic algorithm that is used as a basic building block for higher-level cryptographic operations or schemes) to verify the signature of the JWTs.

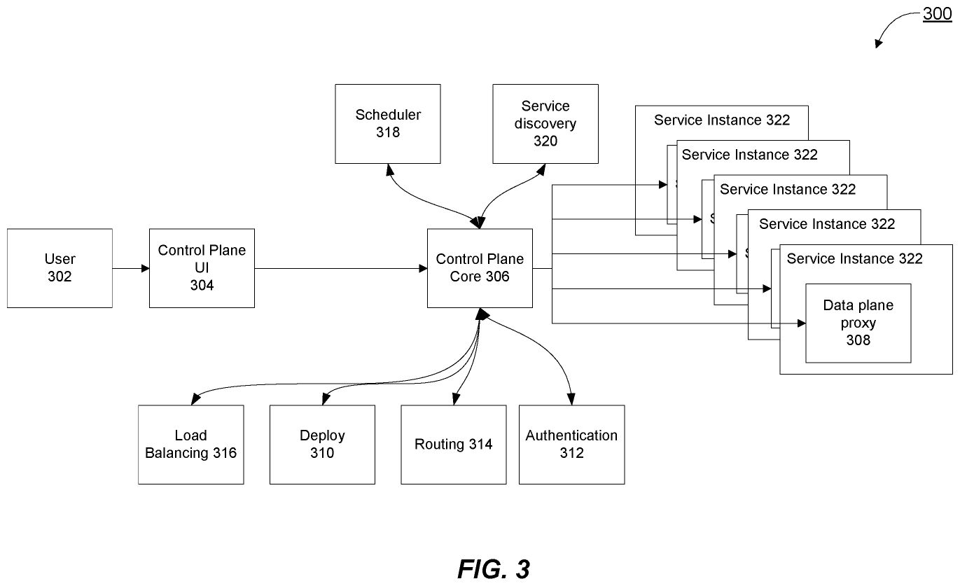

FIG. 3 is a block diagram of a control plane system 300 for a service mesh in a microservices architecture. A service mesh data plane is controlled by a control plane. In a microservices architecture, each microservice typically exposes a set of what are typically fine-grained endpoints, as opposed to a monolithic application where there is just one set of (typically replicated, load-balanced) endpoints. In the example shown in FIG. 3, an endpoint is considered to be a URL pattern used to communicate with an API.

Service mesh data plane: Touches every packet/request in the system. Responsible for service discovery, health checking, routing, load balancing, authentication/authorization, and observability.

Service mesh control plane: Provides policy and configuration for all of the running data planes in the mesh. Does not touch any packets/requests in the system but collects the packets in the system. The control plane turns all the data planes into a distributed system.

A service mesh such as Linkerd, NGINX, HAProxy, Envoy co-locate service instances with a data plane proxy network proxy. Network traffic (HTTP, REST, gRPC, Redis, etc.) from an individual service instance flows via its local data plane proxy to the appropriate destination. Thus, the service instance is not aware of the network at large and only knows about its local proxy. In effect, the distributed system network has been abstracted away from the service programmer. In a service mesh, the data plane proxy performs a number of tasks. Example tasks include service discovery, health checking, routing, load balancing, authentication and authorization, and observability.

Service discovery identifies each of the upstream/backend microservice instances within used by the relevant application. Health checking refers to detection of whether upstream service instances returned by service discovery are ready to accept network traffic. The detection includes both active (e.g., out-of-band pings to an endpoint) and passive (e.g., using 3 consecutive 5xx as an indication of an unhealthy state) health checking. The service mesh is further configured to route requests from local service instances to desired upstream service clusters.

Load balancing: Once an upstream service cluster has been selected during routing, a service mesh is configured load balance. Load balancing includes determining which upstream service instance should the request be sent; with what timeout; with what circuit breaking settings; and if the request fails, should it be retried?

The service mesh further authenticates and authorizes incoming requests cryptographically using mTLS or some other mechanism. Data plane proxies enable observability features including detailed statistics, logging, and distributed tracing data, which are generated so that operators understand distributed traffic flow patterns and debug problems as they occur.

In effect, the data plane proxy is the data plane. Said another way, the data plane is responsible for conditionally translating, forwarding, and observing every network packet that flows to and from a service instance.

The network abstraction that the data plane proxy provides does not inherently include instructions or built-in methods to control the associated service instances in any of the ways described above. The control features are the enabled by a control plane. The control plane takes a set of isolated stateless data plane proxies and turns them into a distributed system.

A service mesh and control plane system 300 includes a user 302 whom interfaces with a control plane UI 304. The UI 304 might be a web portal, a CLI, or some other interface. Through the UI 304, the user 302 has access to the control plane core 306. The control plane core 306 serves as a central point that other control plane services operate through in connection with the data plane proxies 308. Ultimately, the goal of a control plane is to set policy that will eventually be enacted by the data plane. More advanced control planes will abstract more of the system from the operator and require less handholding.

In some examples, control plane services include global system configuration settings such as deploy control 310 (blue/green and/or traffic shifting), authentication and authorization settings 312, route table specification 314 (e.g., when service A requests a command, what happens), load balancer settings 316 (e.g., timeouts, retries, circuit breakers, etc.), a workload scheduler 318, and a service discovery system 320. The scheduler 318 is responsible for bootstrapping a service 322 along with its data plane proxy 308. Services 322 are run on an infrastructure via some type of scheduling system (e.g., Kubernetes® or Nomad). Typical control planes operate in control of control plane services 310-320 that in turn control the data plane proxies 308. Thus, in typical examples, the control plane services 310-320 are intermediaries to the services 322 and associated data plane proxies 308.

As depicted in FIG. 3, the control plane core 306 is the intermediary between the control plane services 310-320 and the data plane proxies 308. Acting as the intermediary, the control plane core 306 removes dependencies that exist in other control plane systems and enables the control plane core 306 to be platform agnostic. The control plane services 310-320 act as managed stores. With managed storages in a cloud deployment, scaling and maintaining the control plane core 306 involves fewer updates. In some examples, the control plane core 306 is split to multiple modules during implementation.

The control plane core 306 passively monitors each service instance 322 via the data plane proxies 308 via live traffic. However, in other instances, the control plane core 306 takes active checks to determine the status or health of the overall application.

The control plane core 306 supports multiple control plane services 310-320 at the same time by defining which one is more important through priorities. Employing a control plane core 306 as disclosed aids control plane service 310-320 migration. Where a user wishes to change the control plane service provider (ex: changing service discovery between Apache Zookeeper™ based discovery to switch to Consul based discovery), a control plane core 306 that receives the output of the control plane services 310-320 from various providers configures each service regardless of provider. Conversely, a control plane that merely directs control plane services 310-320 includes no such configuration store.

Another feature provided by the control plane core 306 is static service addition. For example, a user running Consul may want to add another service/instance (ex: for debugging). However, the user may not want to add the additional service on the Consul cluster. In this example, using the control plane core 306 enables the user to plug the file-based source with custom definition multi-datacenter support. The user exposes the state hold in control plane core 306 as an HTTP endpoint, and plugs the control plane core 306 from other datacenters as a source with lower priority, which provides fallback for instances in the other datacenters when instances from local datacenter are unavailable.

In the context of FIG. 3, each of the service instances 322 include a data plane proxy 308 that has an embedded OPA that enables the service instance to independently approve or deny a request that is forwarded to it by the control plane core 306. Furthermore, when deploying the service mesh shown in FIG. 3, the OPA policy for each of the service instances 322 is customized by the control plane 306 based on the requirements, constraints, and/or capabilities of the service instance. As previously discussed, the embedded OPA negates the need to deploy a separate or additional sidecar to implement policy management and enforcement, and enables standardized authentication and authorization to be implemented out of the box.

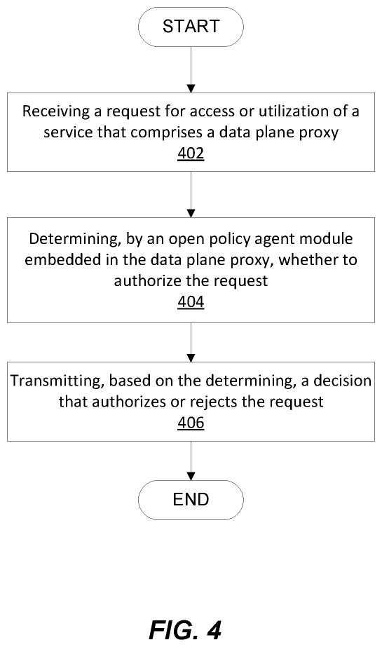

FIG. 4 is a flowchart illustrating a method 400 of authorizing requests in a microservices architecture application comprising multiple services, where each of the multiple services is an application program interface (API) performing a piecemeal function of an overall application function. In operation 402, receiving a request for access or utilization of a service that comprises a data plane proxy. In an example, the service comprises a data plane proxy that is configured to perform at least one of routing, load balancing, authentication and authorization, service discovery, or health checking for the service. In some embodiments, the data plane proxy includes specialized software modules that perform the aforementioned functions and/or tasks. In other embodiments, the data plane proxy includes specialized hardware (e.g., an application-specific integrated circuit (ASIC)) that is specifically designed to optimize that particular function and/or task.

In operation 404, determining, by an open policy agent module embedded in the data plane proxy, whether to authorize the request. In some embodiments, the service is contained within a container, and the OPA module is embedded in the data plane proxy such that the architecture excludes an OPA sidecar service being deployed in the container. In an example, the container is a virtual machine. In another example, the container is a Kubernetes® pod. As previously discussed, the OPA being embedded in the data plane proxy results in the OPA operating within the capabilities, requirements, and/or constraints of the data plane proxy.

In operation 406, transmitting, based on the determining, a decision that authorizes or rejects the request.

In some embodiments, the embedded OPA module is configured to perform API authorization. In an example, this is performed in conjunction with a JSON Web Token that is provided as an input to the embedded OPA.

In some embodiments, and as shown in FIG. 3, the data plane proxy of each of the multiple services is communicatively coupled to an application control plane (e.g., control plane core 306 in FIG. 3). In other embodiments, the application control plane is configured to apply a default policy for the OPA module in the data plane proxy of each of the multiple services upon establishment of the microservice architecture application. In an example, the default policy comprises standardized authentication and authorization rules. In yet other embodiments, the application control plane includes specialized software configured to dynamically adapt to rules and policies that enforce the operation of one or more data plane proxies. For example, the application control plane includes static and dynamic routing tables, as well as implementations of routing protocols (e.g., border gateway protocol (BGP) or open shortest path first (OPSF)) that use the routing tables.

In some embodiments, the method 400 further includes the operations of receiving, upon establishment of the microservice architecture application, a default policy for the OPA module from the application control plane, and installing the default policy on the OPA module. The method 400 still further includes the operations of receiving, from the application control plane, a custom policy configuration for the OPA module that is different from the default policy, and replacing the default policy with the custom policy configuration.

In some embodiments, the decision generated by the embedded OPA is transmitted to the application control plane.

In some embodiments, the request is associated with a token (e.g., a JSON Web Token), the embedded OPA module includes a policy engine, an authorization database, and a policy database, and the determining operation (operation 404) includes the operations of selecting one or more entries in the authorization database that correspond to one or more values in the token, and generating the decision based on applying a policy in the policy database to the one or more values and the one or more authorization entries. In this example, a format of the request, the one or more entries, and the decision is a JavaScript Object Notation (JSON) format, and the policy is formatted using REGO.

Embodiments of the disclosed technology provide a system that includes an application control plane, and a microservice architecture application comprising a plurality of services that interact to perform an overall application function, each of the plurality of services being an application program interface (API) performing a piecemeal function of the overall application function, wherein a service of the plurality of services comprises a data plane proxy that is communicatively coupled to the application control plane, wherein the service is configured to receive (a) a request for access or utilization of the service and (b) a token associated with the request, wherein the data plane proxy comprises an embedded software module that is configured to determine whether to authorize the request, and wherein the application control plane is configured to receive, from the data plane proxy, a decision authorizes or rejects the request.

In some embodiments, the embedded software module is an open policy agent (OPA) module that comprises a policy engine, an authorization database, and a policy database.

In some embodiments, the application control plane is further configured to apply a default policy for the embedded software module in the data plane proxy of each of the plurality of services upon establishment of the microservice architecture application.

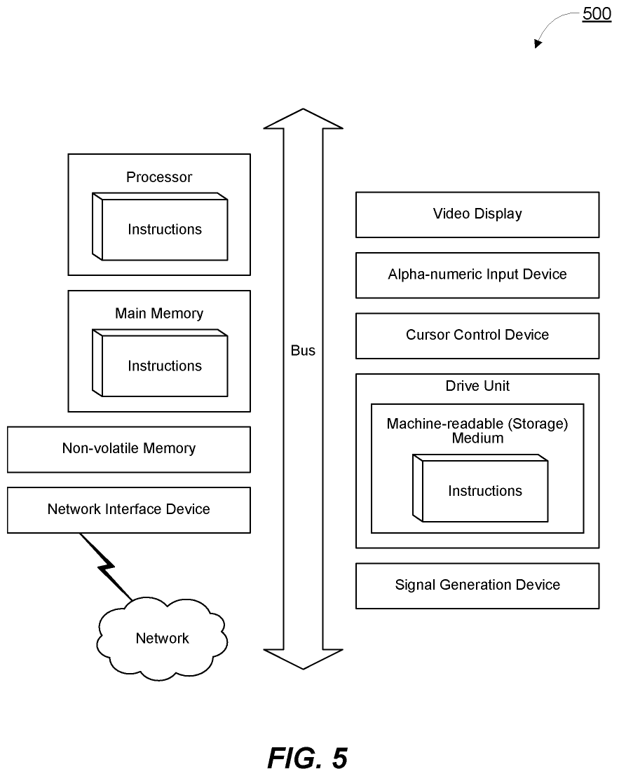

FIG. 5 shows a diagrammatic representation of a machine in the example form of a computer system 500, within which a set of instructions for causing the machine to perform any one or more of the methodologies discussed herein may be executed.

In alternative embodiments, the machine operates as a standalone device or may be connected (networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone or smart phone, a tablet computer, a personal computer, a web appliance, a point-of-sale device, a network router, switch or bridge, or any machine capable of executing a set of instructions (sequential or otherwise) that specify actions to be taken by that machine.

While the machine-readable (storage) medium is shown in an exemplary embodiment to be a single medium, the term “machine-readable (storage) medium” should be taken to include a single medium or multiple media (a centralized or distributed database, and/or associated caches and servers) that store the one or more sets of instructions. The term “machine-readable medium” or “machine readable storage medium” shall also be taken to include any medium that is capable of storing, encoding or carrying a set of instructions for execution by the machine and that cause the machine to perform any one or more of the methodologies of the present invention.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine or computer-readable media include, but are not limited to, recordable type media such as volatile and non-volatile memory devices, floppy and other removable disks, hard disk drives, optical disks (e.g., Compact Disk Read-Only Memory (CD ROMS), Digital Versatile Discs, (DVDs), etc.), among others, and transmission type media such as digital and analog communication links.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

All patents, applications and references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, 16, other aspects may likewise be embodied as a means-plus-function claim, or in other forms, such as being embodied in a computer-readable medium. (Any claims intended to be treated under 35 U.S.C. § 112, 16 will begin with the words “means for.”) Accordingly, the applicant reserves the right to add additional claims after filing the application to pursue such additional claim forms for other aspects of the disclosure.

What is claimed is:

1. A method of authorizing requests in a microservices architecture application comprising a plurality of services, each of the plurality of services being an application program interface (API) performing a piecemeal function of an overall application function, the method comprising:
receiving, by a service of the plurality of services, a request for access or utilization of the service, wherein the service comprises a data plane proxy that is configured to perform at least one of routing, load balancing, authentication and authorization, service discovery, or health checking for the service;
determining, by an open policy agent (OPA) module embedded in the data plane proxy, whether to authorize the request; and
transmitting, based on the determining, a decision that authorizes or rejects the request.

2. The method of claim 1, wherein the service is comprised in a container, and wherein the OPA module being embedded in the data plane proxy excludes an OPA sidecar service being deployed in the container.

3. The method of claim 2, wherein the container is a virtual machine.

4. The method of claim 2, wherein the container is a Kubernetes® pod.

5. The method of claim 1, wherein the OPA module is configured to perform API authorization.

6. The method of claim 5, wherein the data plane proxy of each of the plurality of services is communicatively coupled to an application control plane.

7. The method of claim 6, wherein the application control plane is configured to apply a default policy for the OPA module in the data plane proxy of each of the plurality of services upon establishment of the microservice architecture application.

8. The method of claim 7, wherein the default policy comprises standardized authentication and authorization rules.

9. The method of claim 6, further comprising:
receiving, upon establishment of the microservice architecture application, a default policy for the OPA module from the application control plane; and
installing the default policy on the OPA module.

10. The method of claim 9, further comprising:
receiving, from the application control plane, a custom policy configuration for the OPA module that is different from the default policy; and
replacing the default policy with the custom policy configuration.

11. The method of claim 6, wherein the decision is transmitted to the application control plane.

12. The method of claim 1, wherein the request is associated with a token, wherein the OPA module comprises a policy engine, an authorization database, and a policy database, and wherein the determining comprises:
selecting one or more entries in the authorization database that correspond to one or more values in the token; and
generating the decision based on applying a policy in the policy database to the one or more values and the one or more authorization entries.

13. The method of claim 12, wherein a format of the request, the one or more entries, and the decision is a JavaScript Object Notation (JSON) format, wherein the policy is formatted using REGO, and wherein the token is a JSON Web Token (JWT).

14. A system comprising:
an application control plane; and
a microservice architecture application comprising a plurality of services that interact to perform an overall application function, each of the plurality of services being an application program interface (API) performing a piecemeal function of the overall application function,
wherein a service of the plurality of services comprises a data plane proxy that is communicatively coupled to the application control plane,
wherein the service is configured to receive (a) a request for access or utilization of the service and (b) a token associated with the request,
wherein the data plane proxy comprises an embedded software module that is configured to determine whether to authorize the request, and
wherein the application control plane is configured to receive, from the data plane proxy, a decision authorizes or rejects the request.

15. The system of claim 14, wherein the embedded software module is an open policy agent (OPA) module that comprises a policy engine, an authorization database, and a policy database.

16. The system of claim 15, wherein the service is comprised in a container, and wherein the OPA module being embedded in the data plane proxy excludes an OPA sidecar service being deployed in the container.

17. The system of claim 16, wherein the container is a virtual machine or a Kubernetes® pod.

18. The system of claim 14, wherein the application control plane is further configured to apply a default policy for the embedded software module in the data plane proxy of each of the plurality of services upon establishment of the microservice architecture application.

19. A method of authorizing requests in a microservices architecture application comprising a plurality of services, each of the plurality of services being an application program interface (API) performing a piecemeal function of an overall application function, the method comprising:
receiving, by a service of the plurality of services, (a) a request for access or utilization of the service and (b) a token associated with the request, wherein the service comprises a data plane proxy
determining, by an embedded software module in the data plane proxy, whether to authorize the request; and
transmitting, based on the determining, a decision that authorizes or rejects the request.

20. The method of claim 19, wherein the embedded software module is an open policy agent (OPA) module that comprises a policy engine, an authorization database, and a policy database.
